(19) United States
(12) Patent Application Publication
(10) Pub. No.: US 2026/0044825 A1
(43) Pub. Date: Feb. 12, 2026

(54) GOODS LOGISTICS SYSTEM AND METHOD FOR OPERATING A GOODS LOGISTICS SYSTEM

(71) Applicant: Jungheinrich AG, Hamburg (DE)

(72) Inventors: Stefan HARING, Stainz (AT); Juergen LUTTENBERGER, Wagna (AT); Christian MISCHITZ, Graz (AT)

(73) Assignee: Jungheinrich AG, Hamburg (DE)

(21) Appl. No.: 19/366,977

(22) Filed: Oct. 23, 2025

Related U.S. Application Data
(63) Continuation of application No. PCT/EP2024/059978, filed on Apr. 12, 2024.

(51) Int. Cl. G06Q 10/087; B65G 1/137; B66F 9/06

(52) U.S. Cl. CPC G06Q 10/0877; B65G 1/1373; B66F 9/063; G06Q 10/0872

(57) ABSTRACT

A goods logistics system is provided. The system can include: a master computer, and at least one input unit. The input units can generate a trigger signal and transmit the trigger signal to the master computer. The master computer can generate, change, or delete a transport task to be carried out in a transport region by driverless industrial trucks operating based on the trigger signal with the application of a stored transport task definition and to transmit a transport task signal linked to this transport task to the industrial truck. The transport task signal prompts the industrial truck to perform the transport task. The master computer can change a status loading aid stations assigned to the input units based on the trigger signal with the application of a stored status change definition. The transport task definition and the status change definition are changeable.

### CROSS REFERENCE TO RELATED APPLICATION

The present application is a continuation of PCT/EP2024/059978, filed on Apr. 12, 2024, the entire contents of which is incorporated herein by reference.

### BACKGROUND

### Field

The present disclosure relates to a goods logistics system, comprising a master computer, at least one driverless industrial truck that is configured for operation in a transport region, and at least one input unit, wherein the input unit is configured to generate a trigger signal and transmit same to the master computer. The invention further relates to a method for operating a goods logistics system.

### Prior Art

A goods logistics system is an intralogistics system which serves to handle material and goods within a spatially limited region, for example a company premises or a factory. A goods logistics system does not serve to transport goods outside said closed-off region, which is often the preserve of a forwarding company, and is therefore also referred to as an intralogistics system.

In goods logistics systems, driverless industrial trucks are often used as the transport system. Driverless industrial trucks, which are also referred to as AGVs (automated guided vehicles) or AMRs (autonomous mobile robots) depending on the degree of autonomy, move within a transport region of a goods logistics facility and complete transport tasks. For this purpose, the driverless industrial trucks are controlled by a master computer, which can take on traffic control of the driverless industrial trucks in addition to coordinating the transport tasks.

A transport task typically consists of the task of picking up or collecting a loading aid, for example a pallet or the like on which, for example, a good is arranged, at a loading aid station and taking said loading aid to or delivering same at another loading aid station. The loading aid may be loaded or empty. Various approaches are known for triggering such transportation.

EP 3 268 827 B1 discloses a decentralized system in which transport tasks are started without central control of the driverless industrial trucks being provided. A transport task to be carried out by the driverless industrial truck is started, for example, by actuation of a hand-held device. It is also provided that an occupancy sensor that detects the presence of a corresponding object, for example a good or a corresponding loading aid, and that starts the transport task is present at a goods station. The known system is a stand-alone system which is used in comparatively small goods logistics facilities.

### SUMMARY

An objective of the present disclosure can be to specify a goods logistics system and a method for operating a goods logistics system, wherein the goods logistics system and the method are intended to be flexibly adaptable to changing requirements for a logistics facility, such as with regard to changes in the goods logistics facility, in which a goods logistics system of this kind can be implemented or else in which a method of this kind can be carried out.

The objective can be solved by a goods logistics system, comprising a master computer, at least one driverless industrial truck that can be configured for operation in a transport region, and at least one input unit, wherein the input unit can be configured to generate a trigger signal and transmit same to the master computer, wherein the master computer can be configured to
a) generate, change, or delete a transport task to be carried out in the transport region by the driverless industrial truck based on the trigger signal with the application of a stored transport task definition and to transmit a transport task signal linked to this transport task to the industrial truck, wherein the transport task signal prompts the industrial truck to perform the transport task, and/or
b) change a status of at least one loading aid station assigned to the input unit based on the trigger signal with the application of a stored status change definition such as, to activate or deactivate the loading aid station, wherein
the transport task definition stored in the master computer and/or the status change definition stored in the master computer is/are changeable.

The possible behavioral patterns of the driverless industrial truck or the change in the status of the loading aid station can be flexibly adapted by changing the transport task definition. The reaction exhibited by the system to a corresponding trigger signal generated by the input unit can be flexibly changed. The behavior of the goods logistics system can be flexibly adapted to customer wishes and also during ongoing operation. This allows for an unprecedented level of flexibility and adaptability of the goods logistics system to different specifications and changing requirements. The transport task definition and the status change definition are, for example, stored in a file which can be saved in a non-volatile data memory of the master computer. The definitions are defined within an adaptable parameter space based on which the behavior of the system can be flexibly adapted. A particular behavior of the system can be defined for each input unit and each generated trigger signal. Unlike in conventional systems, this definition, i.e., for example, the transport task specifically generated in response to a particular trigger signal of a particular input unit, can be flexibly defined at the master computer or at a configuration unit.

The input unit can be configured to generate a trigger signal. Said signal can be transmitted to the master computer by the master computer querying the corresponding state of the input unit, such as cyclically.

According to an embodiment, the goods logistics system can be further developed in that it comprises a configuration unit, wherein the master computer can be configured to grant the configuration unit access to the transport task definition and/or status change definition.

The goods logistics system can be implemented, for example, in a goods logistics system. The configuration unit may be arranged within the goods logistics facility or be a part thereof. In another example, it may be an external unit which can be arranged outside the logistics facility. The configuration unit is, for example, a computer. The transport task definition and/or the status change definition can be changed and adapted with the aid of the configuration unit. This can also take place by means of a third party, for example a service provider or manufacturer of the goods logistics facility. In this way, the goods logistics system can be adapted or optimized using external services. The transport task definition and/or the status change definition can be changed at the master computer itself or at the configuration unit.

The input unit may be assigned, such as permanently, to one or more of the loading aid stations. This assignment can be functional and defined, such as by the transport task. A spatial assignment between the input unit and the loading aid station can be provided. The input unit may be assigned to a single, particular loading aid station. If this input unit generates a trigger signal that can be queried by the master computer, the master computer generates, for example, a transport task which includes this loading aid station as the starting point. The trigger signal may be generated based on manual actuation of the input unit or in a sensor-controlled manner. For example, the input unit may be an occupancy sensor. As soon as said occupancy sensor detects the presence of a loading aid in the loading aid station, a corresponding trigger signal can be generated, such that the master computer generates a transport task in which said loading aid station can be defined as the starting point.

If the input unit can be functionally assigned to multiple loading aid stations, it may serve as the trigger for transportation for a list of sensor-managed start loading aid stations. First, the input unit generates a trigger signal, for example in response to manual actuation. This combination of the input unit and trigger signal stored in the master computer causes a state change, for example an occupancy, to be queried for the loading aid stations present in the list. For example, the occupancy sensors present at the loading aid stations and designed as input units and indicating whether the loading aid stations are full or empty are queried. Subsequently, a transport task can be generated for the loading aid station for which occupancy can be indicated in accordance with the configuration stored in the master computer.

The trigger signal can be queried cyclically by the master computer. A state change of the loading aid station or a manually triggered command can be transmitted by the input unit to the master computer by way of the trigger signal. The master computer can then generate, change, or delete a transport task, which takes place from or to the loading aid station, wherein the related behavior of the goods logistics system results from the transport task definition in the master computer.

According to another embodiment, the input unit can be a manually actuated button or an occupancy sensor which can be configured to generate the trigger signal in response to manual actuation or detection of the presence of a loading aid.

The input unit can be, for example, a push button or illuminated pushbutton. An operator may actuate a button of this kind in order, for example, to manually generate, change, or delete a transport task. The specific transport task generated in response to the trigger signal of an input unit assigned to a particular loading aid station can be stored in the transport task definition and can be flexibly changed. Thus, the behavior of the goods logistics system can be adapted to changing circumstances without said system having to be operated differently. The occupancy sensor can be, for example, a contactlessly operating sensor which detects the presence of a loading aid at a station, for example using a light barrier. Equally, the occupancy sensor may not operate contactlessly and be designed accordingly, for example as a weight sensor or as a touch or contact sensor. A trigger signal can also be generated on the basis of data of such sensors and transmitted to the master computer. The master computer generates, for example, a transport task according to which a loading aid can be collected at the loading aid station. If a loading aid can be detected at another station, for example based on the weight, a different transport task can be generated. In turn, the specific transport task can be generated on the basis of the transport task definition, wherein the same can be flexibly adapted to the respective needs.

An input unit, for example a button, may be provided and configured to generate a trigger signal which prompts a status change of the loading aid station linked to the input unit in accordance with the status change definition. For example, the associated loading aid station can be activated or deactivated by actuating the corresponding input unit. Active loading aid stations can be approached in the system. Deactivated loading aid stations cannot be approached, for example because no operating personnel can be available there. Deactivation of the loading aid station means that same can no longer be approached in the goods logistics system, since, for example, it can be no longer present as such in the system. This may mean, for example, that the input unit recognizes that a loading aid station can be occupied by a loading aid, for example a pallet, and in response thereto triggers a trigger signal which can be queried by the master computer and can be converted into a transport task signal. If the loading aid station can be still occupied due to the loading aid not having been transported away by an industrial truck, the loading aid station cannot be occupied by another loading aid and can be therefore, for example, deactivated for the delivery of pallets, but can be released for transporting same away.

According to another embodiment, the goods logistics system can be further developed in that at least a first loading aid station and a second loading aid station, which are interconnected by a transport path, are present in the transport region, wherein the transport task consists in conveying loading aids from the first loading aid station to the second loading aid station.

A transport task of this kind can be the simplest but also most common type of transport task.

According to another embodiment, the goods logistics system can be further developed in that the master computer can be configured to provide sequence control for the transport tasks and/or traffic control for the driverless industrial trucks in the transport region and to generate the transport task intended for transmission to the industrial truck taking into account the parameters of the sequence control and/or traffic control. For example, the available or else free industrial truck located spatially closest to the loading aid station can receive the transport task.

During processing of the transport tasks generated by manual or automatic actuation of the input unit (by means of the trigger signal), the general sequence control of the goods logistics system can be taken into account, such that the generated transport tasks can be integrated as best as possible in ongoing operation.

According to another embodiment, the goods logistics system can be implemented in a goods logistics facility, wherein the goods logistics facility can be realized on the basis of a planning model and using data saved in a logistics facility project file, and wherein the logistics facility project file comprises data that describe properties of at least one of the following components of the goods logistics facility: structural properties of a building of the goods logistics facility, geometric and/or functional properties of the transport region and/or transport path, geometric and/or functional properties of logistics infrastructure elements, such as, of the first and second loading aid station, geometric and/or functional properties of the driverless industrial truck, wherein parameters of the transport task definition are further stored in the logistics facility project file.

According to another embodiment, the changeable transport task definition can be defined in a causally linked parameter space and can be changed at the master computer or configuration unit. The parameter space comprises the following parameters:
a) input units present in the goods logistics system such as all present input units,
b) for each input unit included, one or more possible types of trigger signals that can be generated thereby, and
c) for each trigger signal of each input unit, one or more status change request(s) of a transport task, such as for generating, changing, or deleting same.

As specified above, the parameter space can comprise the input units present in the goods logistics system, i.e., for example, buttons, illuminated buttons, or occupancy sensors. It can be also possible to define in the corresponding parameter the loading aid station to which the corresponding input units are assigned. One input unit or multiple input units may be provided per loading aid station.

Furthermore, it can be defined for each individual input unit which trigger signals the corresponding input units can generate. The various trigger signals should be referred to as various types of trigger signal. A type of trigger signal is, for example, pressing a button for approximately 1 second. A further type of trigger signal would, for example, be the button being pressed for approx. 3 seconds. A further trigger signal would be the signal of an occupancy sensor that indicates that a loading aid can be located in the loading aid station. In such a case, a distinction can again be made, and specifically between a trigger signal that indicates the occupancy of the loading aid station and a trigger signal that indicates that the loading aid station can be not occupied.

A status change request of a transport task for generating, changing, or deleting said transport task, can be configured for each of the trigger signals of each input unit.

For example, it can be provided for a particular input unit that, for a trigger signal indicating that the pushbutton was pressed for approx. 3 seconds, the last transport task starting at the loading aid station to which this input unit can be assigned can be deleted. A further example would be an input unit that can be designed as an occupancy sensor. If a loading aid can be present at the associated loading aid station, and this input unit detects the loading aid, a transport task which takes the loading aid from the relevant loading aid station to a desired target station configured in the master computer can be automatically triggered.

In another embodiment, the parameter space further comprises the following as parameters:
for each transport task, provided that the status change request specifies generating or changing same,
d) a start loading aid station or a group of start loading aid stations, and
e) a destination loading aid station or a group of destination loading aid stations. These additional parameters apply for each transport task, provided that same can be generated or changed.

As an alternative to a start loading aid station that can be configured in the master computer and to a destination loading aid station that can be configured for the transport task in the master computer, groups of start loading aid stations and destination loading aid stations can be defined. These groups can be combined with additional information.

Building on the above-mentioned example, if, for example, a loading aid can be detected at the loading aid station, a transport task can be generated which includes a group of loading aid stations rather than a single loading aid station as the destination loading aid station. If, for example, corresponding occupancy sensors at the destination loading aid stations then indicate that a loading aid station of the group of destination loading aid stations can be fully occupied, the master computer can automatically change the transport task and divert the transport task from the fully occupied destination loading aid station to a destination loading aid station that can be occupied to a lesser extent. This destination loading aid station can be selected from the group of destination loading aid stations. It can be also provided that the transport task can be generated directly with another free destination loading aid station of the possible destination loading aid stations.

This example also leads to another embodiment, according to which the goods logistics system can be further developed in that the parameters d) and/or e) is/are additionally causally linked to:
i) a sensor signal of an occupancy sensor of the start loading aid station or sensor signals of occupancy sensors of the group of start loading aid stations which indicates/indicate whether the loading aid station(s) is/are free or occupied, and/or
ii) a parameter of the sequence control of the transport tasks and/or traffic control of the driverless industrial trucks in the transport region which indicates whether the loading aid station can be free or occupied, wherein the transport task can be only generated if the start loading aid station can be occupied and the destination loading aid station can be free.

Furthermore, in the case of multiple possible destination loading aid stations of the group of destination loading aid stations, the destination loading aid station to be approached can be determined based on further criteria that take into account the sequence control and/or traffic control in the goods logistics system. For example, stored priorities of the destination loading aid station or the spatial proximity to the start loading aid station can be taken into account.

According to another embodiment, it can be provided that the destination loading aid station can be defined by means of a user input at the industrial truck or the target selection can be manually made on a client (application on a PC), for example at the master computer.

The sequence control or traffic control can be taken into account in such a way that, in one application scenario for example, in which an industrial truck can be required for a transport task, the industrial truck located spatially closest to the start loading aid station can be used for this transport task.

The above-mentioned components of the goods logistics facility can be stored in digital form in the logistics facility project file. The goods logistics facility project file can thus partially fulfill the function of a digital twin of the goods logistics facility. However, the goods logistics facility project file flexibly can make available at least the information required for changing, extending, or maintaining the goods logistics facility, such that corresponding changes can be made to the goods logistics facility without a problem. The transport task definition as well as the status change definition can be integrated in this digital representation of the goods logistics facility. Thus, the functionality of the goods logistics system can be integrated into the digital representation saved in the logistics facility project file.

The object can be further achieved by a method for operating a goods logistics system that comprises a master computer, at least one driverless industrial truck configured for operation in a transport region, and at least one input unit. The method comprises:
generating a trigger signal at the input unit and transmitting the trigger signal to the master computer,
wherein the master computer
   a) generates, changes, or deletes a transport task to be carried out in the transport region by the driverless industrial truck based on the trigger signal with the application of a stored transport task definition and transmits a transport task signal linked to this transport task to the industrial truck, wherein the industrial truck performs the transport task in response to the transport task signal, and/or
   b) changes a status of at least one loading aid station assigned to the input unit based on the trigger signal with the application of a stored status change definition activates or deactivates the loading aid station, wherein
the transport task definition stored in the master computer and/or the status change definition stored in the master computer is/are changeable.

The same or similar advantages apply to the method of carrying out a transport task that were already mentioned above with reference to the goods logistics system itself, and they will therefore not be repeated.

The method can be further developed in that the goods logistics system further comprises a configuration unit, wherein the master computer grants the configuration unit access to the transport task definition and/or status change definition and the configuration unit changes the transport task definition and/or status change definition.

According to another embodiment, the input unit can be a manually actuated button or an occupancy sensor, wherein the trigger signal can be generated in response to manual actuation of the button or in response to the presence of a loading aid being detected.

At least a first loading aid station and a second loading aid station, which are interconnected by a transport path, can be present in the transport region, wherein, when the transport task can be performed, at least one loading aid can be conveyed from the first loading aid station to the second loading aid station.

According to another embodiment, the master computer can provide sequence control for the transport tasks and/or traffic control for the driverless industrial trucks in the transport region and generates the transport task taking into account the parameters of the sequence control and/or traffic control.

According to another embodiment, the goods logistics system can be implemented in a goods logistics facility, wherein the goods logistics facility can be realized on the basis of a planning model and using data saved in a logistics facility project file, and wherein the logistics facility project file comprises data that describe properties of at least one of the following components of the goods logistics facility:
structural properties of a building of the goods logistics facility,
geometric and/or functional properties of the transport region and/or transport path,
geometric and/or functional properties of logistics infrastructure elements, such as, of the first and second loading aid station,
geometric and/or functional properties of the driverless industrial truck,
wherein parameters of the transport task definition are further stored in the logistics facility project file.

According to another embodiment, the changeable transport task definition can be defined in a causally linked parameter space and can be changed by the master computer or configuration unit, and the parameter space comprises the following as parameters:
a) input units present in the goods logistics system or all present input units,
b) for each input unit included, one or more possible types of trigger signals that can be generated thereby, and
c) for each trigger signal of each input unit, one or more status change request(s) of a transport task, for generating, changing, or deleting same, and for each transport task, if the status change request specifies generating or changing same:
d) a start loading aid station or a group of start loading aid stations, and
e) a destination loading aid station or a group of destination loading aid stations, wherein the parameters d) and/or e) can be additionally causally linked to:
   i) a sensor signal of an occupancy sensor of the start loading aid station or sensor signals of occupancy sensors of the group of start loading aid stations which indicates/indicate whether the loading aid station(s) is/are free or occupied, and/or
   ii) a parameter of the sequence control of the transport tasks and/or traffic control of the driverless industrial trucks in the transport region which indicates whether the loading aid station can be free or occupied, wherein the transport task can be only generated if the start loading aid station can be occupied and the destination loading aid station can be free.

Furthermore, in the case of multiple possible destination loading aid stations of the group of destination loading aid stations, the destination loading aid station to be approached can be determined based on further criteria that are predefined by the sequence control and/or traffic control, for example according to stored priorities of the destination loading aid stations or the spatial proximity to the start loading aid station.

The described goods logistics system and the described method can be used in the field of driverless transport systems (DTS). Driverless transport vehicles (DTV) must be supplied with transport tasks in such a DTS in order to be able to transport goods and loading aids accordingly in a goods logistics facility. Such transport tasks relate, for example, to the collection of goods and/or loading aid from a first loading aid station and delivering the goods and loading aids at a second loading aid station. In order to trigger transportation of this kind, manual inputs can, for example, be made by a user at an input unit. An input unit of this kind is, for example, a pushbutton, an illuminated pushbutton, or a digitally represented touch-sensitive surface. Furthermore, automatic systems may be provided in order to trigger transportation, i.e. a corresponding transport task. For this purpose, occupancy sensors, for example, are provided. Triggered cyclically or by the master computer, these sensors can check for the presence of goods or loading aids at a loading aid station. If a loading aid can be detected, a corresponding transport task can be generated.

The goods logistics system or the method for operating the goods logistics system can allow for a flexible and changeable transport task definition or status change definition. These define the transport task or status change of the loading aid station triggered by a corresponding input at the input unit. The system can support the user with the configuration of the sequence control by providing a causally linked parameter space based on which the transport task definition or status change definition are defined for each individual input unit of the goods logistics system and for each individual trigger signal that can be generated by the corresponding input unit. Thus, the behavior of the industrial trucks and loading aid stations can be flexibly defined or configured. Such a configuration can be saved in a goods logistics facility project file together with further definitions, for example the structural properties of a building of the goods logistics facility, the geometric and/or functional properties of the transport region, the geometric and/or functional properties of logistics infrastructure elements, and/or geometric and/or functional properties of the driverless industrial truck.

During commissioning of the goods logistics facility, the corresponding information of the logistics facility project file can be transmitted to the master computer. Subsequently, the desired behavior of the goods logistics system that was previously configured and defined sets in. This configuration can be changed and adapted at any time, which lends an unprecedented level of flexibility to a goods logistics facility equipped with a goods logistics system according to aspects of the present disclosure.

### BRIEF DESCRIPTION OF THE DRAWINGS

Further features will become evident from the description of embodiments together with the claims and the accompanying drawings. Embodiments can fulfill individual features or a combination of multiple features.

The embodiments will be described below, without restricting the general concept of the invention, based on exemplary embodiments and with reference to the drawings, wherein reference is expressly made to the drawings regarding all of the details which are not explained in greater detail in the text. In the figures:

FIG. 1 illustrates a schematic representation of a goods logistics facility in which a goods logistics system is implemented, and

FIG. 2 illustrates a schematic functional representation of a goods logistics system.

In the drawings, the same or similar elements and/or parts are, in each case, provided with the same reference signs, and therefore they are not introduced again in each case.

### DETAILED DESCRIPTION

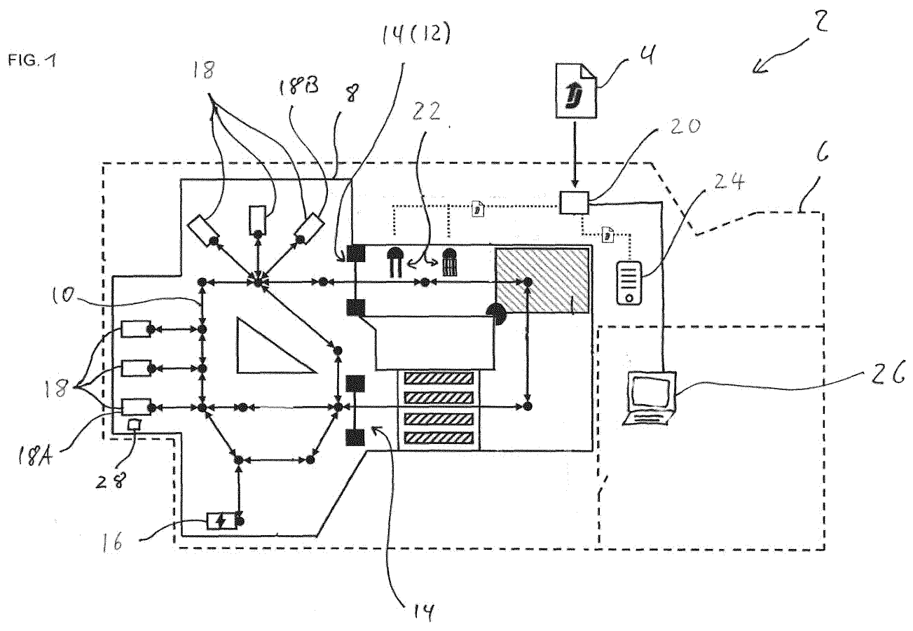

The goods logistics facility 2 represented schematically in FIG. 1 comprises a building 6, which is represented as a dashed line in the form of a building outline. A transport region 8 and transport paths 10 are located in the goods logistics facility 2. The transport region 8 is represented as a correspondingly designated polygon. A further boundary of the transport region 8 is located in the center, which defines an empty space. The transport paths 10 are represented by arrows. The goods logistics facility 2 comprises logistics infrastructure elements 12. By way of example, roller shutter doors 14, a charging station 16, and multiple loading aid stations 18 are represented. A goods logistics system is implemented in the goods logistics facility 2. Said system comprises a master computer 20, in which a changeable transport task definition and/or a changeable status change definition is/are stored. For example, this information is saved in a logistics facility project file 4, which can be transmitted to the master computer 20 during commissioning of the goods logistics facility 2. Driverless industrial trucks 22 operate in the transport region 8. The master computer 20 provides corresponding traffic control for the operation of the driverless industrial trucks 22. Furthermore, the goods logistics system comprises an input unit 24, which is configured to generate a trigger signal in response, for example, to manual actuation of one of the buttons thereof.

The definition as to which type of transportation is generated based on which trigger signal is defined in the transport task definition, which is stored in the master computer 20. The transport task definition is stored, by way of example, in the logistics facility project file 4. The master computer 20 has a data connection to the input unit 24. The trigger signal generated in the input unit 24 is transmitted to the master computer 20. The master computer 20 is further configured to generate a transport task to be carried out within the transport region 8 by one of the driverless industrial trucks 22. Accordingly, this transport task, or else a transport task signal comprising or characterizing the transport task, is transmitted to the industrial truck 22.

The transport task transmitted from the master computer 20 to the industrial truck 22 prompts the industrial truck 22 to perform the corresponding transport task. The master computer 20 can generate the transport task, change the transport task, or delete the transport task proceeding from the trigger signal of the input unit 24. The master computer 20 may further be configured to change a status of a loading aid station 18 linked to the input unit 24 on the basis of the trigger signal. For example, the loading aid station 18 can be activated or deactivated. The manner in which the master computer 20 responds to the receipt of the trigger signal is stored in the transport task definition or else the status change definition, which may form part of the logistics facility project file 4.

The goods logistics system may further comprise a configuration unit 26, wherein the master computer 20 is configured to grant the configuration unit 26 access to the transport task definition and/or status change definition. For example, the master computer 20 is configured to grant the configuration unit 26 access to the logistics facility project file 4. The configuration unit 26 is represented, by way of example, as an internal unit, i.e. it is part of the goods logistics facility 2. The configuration unit 26 may also be an external computer, for example the computer of an externally commissioned service provider or the manufacturer of the goods logistics system.

The input unit 24 is represented, by way of example, as a mobile unit. The input unit 24 can be permanently functionally assigned to a loading aid station 18. As a general rule, the input unit 24 is a stationary unit that is, for example, spatially assigned directly to one of the loading aid stations 18. The input unit 24 is, for example, a manually actuated input unit 24, for example a pushbutton. A trigger signal is generated at the input unit 24, for example, by pressing the pushbutton for one second. The input unit 24 may also be an illuminated pushbutton that again generates a corresponding trigger signal when actuated for one second. The trigger signal is transmitted from the input unit 24 to the master computer 20 or is queried thereby. An alternative trigger signal is, for example, an illuminated pushbutton being pressed for five seconds. Different trigger signals can be generated by a button being actuated for different lengths of time. The master computer 20 responds to the receipt of the corresponding trigger signals with different actions, as defined in the transport task definition or else the status change definition. For example, briefly actuating a button can generate a trigger signal at a loading aid station 18 that prompts the master computer 20 to generate a transport task that prompts transportation of a loading aid from the relevant loading aid station 18 to a further loading aid station 18. The pushbutton can be actuated for a long time to delete the previously generated transport task again. It can also be provided that briefly actuating a button activates the associated loading aid station 18, whereas actuating the button for a long time deactivates the loading aid station 18. It is also conceivable that various buttons, i.e. various input units 24 or various buttons of an input unit 24, can be used to generate various transport tasks to various destinations or with different priorities. Equally, various input units 24 can be used to generate, for example, a transport task on the one hand and to bring about a status change of the loading aid station 18 on the other hand. With regard to the transport tasks, the sequence of the transport tasks to be processed can be specified by the master computer 20, such that higher-priority transport tasks are preferentially processed. Such prioritization can, for example, also be generated by actuating a corresponding button as the input unit. In other words, an input unit 24 (for example a button) that makes it possible to prioritize a generated transport task may, for example, be present at a loading aid station 18.

The input unit 24 may also be designed as an occupancy sensor 28. An occupancy sensor 28 of this kind is represented by way of example for one of the loading aid stations 18. The occupancy sensor 28 may be configured to detect the presence of a loading aid in a loading aid station 18. If the presence of a loading aid is detected, a trigger signal which changes the state of the loading aid station 18 (full or empty) can be generated. The trigger signal is transmitted from the input unit 24 designed as an occupancy sensor to the master computer 20, and the master computer 20 generates a corresponding transport task from this information. The occupancy sensor 28 may be a contactless sensor, but it may also be a contact sensor which, for example, is activated by physical triggering of a contact or which responds in a weight-sensitive manner.

If an occupancy sensor 28 detects a loading aid, a transport task can be automatically triggered which defines the transportation of the relevant loading aid from the associated or assigned loading aid station 18 to a destination loading aid station. For example, such transportation takes place between a first loading aid station 18A and a second loading aid station 18B. This automatically means that the presence of a loading aid is detected in the first loading aid station 18A by means of a suitable input unit 24, which transmits a trigger signal to the master computer 20 in response hereto. The master computer 20 generates the transport task in accordance with the configured transport task definition in response to the trigger signal. The transport task is processed by an industrial truck 22 when a corresponding transport task signal is transmitted to the industrial truck 22. The transmission of a transport task and the transmission of a transport task signal are used synonymously in the context of the following description. Indeed, the transmission of a transport task of course takes place by transmitting a corresponding transport task signal. The two loading aid stations 18A, 18B are interconnected by a transport path 10. The transport path 10 extends within the transport region 8.

The master computer 20 is further configured to provide sequence control for the transport tasks and/or traffic control for the driverless industrial trucks 22 in the transport region 8. Thus, the carrying out or performance of the transport tasks can be optimally integrated in the logistics control of the goods logistics facility 2. In other words, when the transport task signal is transmitted from the master computer 20 to the industrial truck 22, the parameters of the sequence control and/or the parameters of the traffic control are taken into account.

The goods logistics facility 2 can be realized on the basis of a planning model using the logistics facility project file 4. The logistics facility project file 4 comprises data that describe, for example, properties of at least one of the following components of the goods logistics facility 2: structural properties of the building 6 of the goods logistics facility 2, geometric and/or functional properties of the transport region 8 and/or transport paths 10, geometric and/or functional properties of logistics infrastructure elements 12, for example, roller shutter doors 14, loading aid stations 18, geometric and/or functional properties of the driverless industrial truck 22. The changeable transport task definition that defines the transport task to be carried out by the driverless industrial truck 22 is also stored in a planning model which is saved in the logistics facility project file 4.

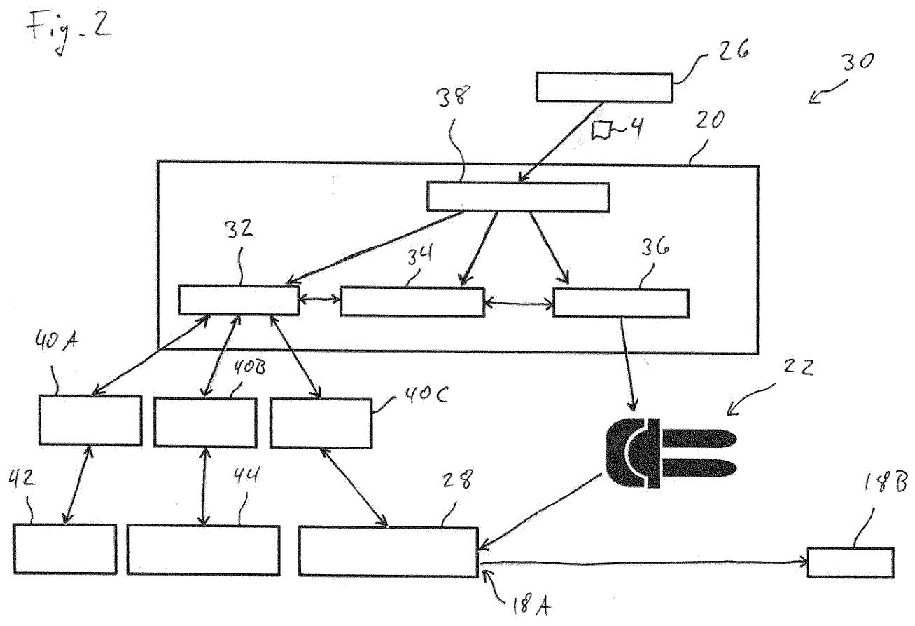

FIG. 2 shows a schematic functional representation of the goods logistics system 30. Said system comprises the configuration unit 26, in which, for example, the logistics facility project file 4 is generated. Said file is transmitted to the master computer 20. The master computer 20 comprises an input/output unit 32, a unit for sequence control 34, and a traffic controller 36. All of these units 32, 34, 36 are supplied with corresponding information from the logistics facility project file. For this purpose, the master computer 20 comprises a corresponding distribution unit 38.

Various input/output systems 40A, 40B, 40C are communicatively coupled to the input/output unit 32. The first input/output system 40A is coupled to one or more pushbuttons 42 as input unit(s). The second input/output system 40B is coupled to one or more illuminated pushbuttons 44 as further exemplary input unit(s). Each of these input units (24) is functionally assigned to a loading aid station 18. The third input/output system 40C is coupled to a loading aid station 18 with sensor monitoring, specifically to the occupancy sensor 28 present there. Said occupancy sensor establishes, for example, that a corresponding loading aid is present at the first loading aid station 18A. This information is communicated along the described information chain to the master computer 20. A transport task is then generated in the master computer 20 in accordance with the transport task definition. Said transport task is communicated via the traffic controller 36 to the industrial truck 22. The industrial truck 22 then travels to the first loading aid station 18A, and carries out, for example, transportation to the second loading aid station 18B according to the received transport task.

The sequence control, which forms the basis for creating a transport task, can be defined, for example, at the master computer 20 or at the configuration unit 26. A definition that is subsequently stored as a transport task definition in the master computer 20 can, for example, be made as follows:

In a first step, the peripheral unit is selected, i.e. the input unit 24, which is preferably assigned to a loading aid station 18. For example, a button, an illuminated pushbutton, or an occupancy sensor is selected.

In a second step, a trigger signal, which the master computer 20 obtains from the input unit 24, is selected. The trigger signals present for an input unit 24 in the system depend on the type of input unit 24 used and installed in the goods logistics facility and are stored with the installation in the system. Thus, a possible trigger signal of an input unit 24 for which the system behavior is to be configured is selected. The input unit 24 may be configured to emit various trigger signals. These various trigger signals are generated, for example, by actuating a pushbutton for different lengths of time. For example, if a pushbutton as the input unit 24 is pressed for a short time, this generates a transport task which includes the loading aid station 18 assigned to the input unit 24 as the start loading aid station. A trigger signal which is generated by actuating, for example, a pushbutton for a long time, for example actuating the pushbutton for approx. 3 seconds, can lead to the master computer 20 deleting the previously generated transport task again.

In a third step, a status change request of a transport task, for example to generate, change, or delete a transport task, is selected for the corresponding trigger signal of the input unit 24 at the master computer 20 or configuration unit 26.

In a fourth step, a start loading aid station and/or destination loading aid station can be selected for the status change request of the trigger signal of the input unit 24 at the master computer 20 or configuration unit 26. One or more start loading aid stations and/or destination loading aid stations can be selected here. Depending on whether a transport task (transportation away) for a loading aid from a start loading aid station is generated or changed or whether a transport task (delivery) to a destination loading aid station is generated or changed, in the first case, it can be provided that only one start loading aid station but multiple destination loading aid stations can be selected and, in the second case, it can be provided that only one destination loading aid station but multiple possible start loading aid stations can be selected.

Further causalities in the sequence control can be taken into account depending on the definition of the transport task. For example, sensor querying of the selected loading aid station can be provided for the destination loading aid station, which establishes whether the destination loading aid station in question is free or occupied. In such a case, the transport task would only be generated if the destination loading aid station is actually free, and thus available for the transport task. Alternatively, the selection of the destination loading aid station can be defined in such a way that the selection thereof takes place by means of a user input on the vehicle display. When defining the sequence control, it can also be provided that the master computer 20 checks whether the capacity of the destination loading aid station is sufficient for the relevant transport task. Such information can be present in the master computer 20 for the purpose of sequence control. It can also be provided that a group of loading aid stations is defined as the destination loading aid station instead of a single loading aid station. The selection as to which specific loading aid station is selected as the actual destination loading aid station can also be made by the system, for example, based on the occupancy of the loading aid stations. In such a case, the system selects the destination loading aid station that still has sufficient receiving capacity for the relevant transport task. If multiple destination loading aid stations are available, a selection can take place according to further criteria, for example a prioritization of the various destination loading aid stations or the proximity to the start loading aid station.

The transport task can also be defined flexibly with regard to the start loading aid station in the same or a similar way to that described above for the destination loading aid station. For example, the loading aid station for which an associated occupancy sensor as the input unit 24 indicates that a loading aid is actually present in the relevant start loading aid station can be selected as the start loading aid station. A corresponding transport task is only generated if this information is positively confirmed by a corresponding occupancy sensor. Similarly, the master computer 20 can also select the start loading aid station for the transport task if a group of loading aid stations rather than a specific loading aid station is defined as the start loading aid station. For example, the master computer 20 can select the start loading aid station with the highest occupancy taking into account the sequence control thereof, such that over-occupancy of the relevant loading aid station that may potentially occur in the near future can be prevented beforehand.

The goods logistics system supports the user with the configuration of the sequence control for generating transport tasks by means of the above-described causally linked selection. It can be provided in the system that it is only possible to combine peripheral units, i.e. input units 24 and loading aid stations 18, and trigger signals for transport tasks that are actually present in the system and can be logically processed thereby.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

2 Goods logistics facility
4 Logistics facility project file
6 Building
8 Transport region
10 Transport path
12 Logistics infrastructure element
14 Roller shutter door
16 Charging station
18 Loading aid station
18A First loading aid station
18B Second loading aid station
20 Master computer
22 Industrial truck
24 Input unit
26 Configuration unit
28 Occupancy sensor
30 Goods logistics system
32 Input/output unit
34 Sequence control(ler)
36 Traffic control(ler)
38 Distribution unit
40A, 40B, 40C First to third input/output system
42 Pushbutton
44 Illuminated pushbutton

What is claimed is:

1. A goods logistics system, comprising:
a master computer, and
at least one input unit, wherein the at least one input unit is configured to generate a trigger signal and transmit the trigger signal to the master computer,
wherein the master computer is configured to:
a) generate, change, or delete a transport task to be carried out in a transport region by at least one driverless industrial truck operating within the transport region based on the trigger signal with the application of a stored transport task definition and to transmit a transport task signal linked to this transport task to the at least one driverless industrial truck, wherein the transport task signal prompts the at least one driverless industrial truck to perform the transport task, and/or
b) change a status of at least one loading aid station assigned to the at least one input units based on the trigger signal with the application of a stored status change definition, wherein
the transport task definition stored in the master computer and the status change definition stored in the master computer are changeable.

2. The goods logistics system according to claim 1, further comprising a secondary computer, wherein the master computer is configured to grant the secondary computer access to the transport task definition and/or status change definition.

3. The goods logistics system according to claim 1, wherein the at least one input units is one of a manually actuated button or an occupancy sensor configured to generate the trigger signal in response to manual actuation or detection of the presence of a loading aid.

4. The goods logistics system according to claim 1, wherein the transport task comprises conveying a loading-aid from a first loading-aid station to a second loading-aid station along a transport path within the transport region.

5. The goods logistics system according to claim 1, wherein the master computer is configured to provide sequence control for the transport task and/or traffic control for the at least one driverless industrial trucks in the transport region and to generate the transport task based on the parameters of the sequence control and/or traffic control.

6. The goods logistics system according to claim 5, implemented in a goods logistics facility, wherein the goods logistics facility is realized on the basis of a planning model and using data saved in a logistics facility project file, and wherein the logistics facility project file comprises data that describe properties of at least one of the following components of the goods logistics facility:
structural properties of a building of the goods logistics facility,
geometric and/or functional properties of the transport region and/or transport path,
geometric and/or functional properties of logistics infrastructure elements of the first and second loading aid station, or
geometric and/or functional properties of the at least one driverless industrial truck,
wherein parameters of the transport task definition are further stored in the logistics facility project file.

7. The goods logistics system according to claim 5, wherein the transport task definition is defined in a causally linked parameter space and changed at one of the master computer or secondary computer, and the parameter space comprises the following as parameters:
a) the at least one input units present in the goods logistics system or all present input units,
b) for each input unit of the at least one input units included, one or more possible types of trigger signals that can be generated thereby, and
c) for each trigger signal of each input unit of the at least one input units, one or more status change request(s) of a transport task for generating, changing, or deleting the transport task.

8. The goods logistics system according to claim 7, wherein the parameter space further comprises the following as parameters:
for each transport task, provided that the status change request specifies generating or changing same, the parameter space further comprises the following as parameters:
d) at least one start loading aid station, and
e) at least one destination loading aid stations.

9. The goods logistics system according to claim 8, wherein the parameter d) is additionally causally linked to:
i) at least one sensor signal of at least one occupancy sensor of the at least one start loading aid station which indicate whether the loading aid stations are free or occupied, and/or
ii) a parameter of the sequence control of the transport tasks and/or traffic control of the at least one driverless industrial trucks in the transport region which indicates whether the loading aid station is free or occupied,
wherein the transport task is only generated if the start loading aid station is occupied and the destination loading aid station is free.

10. The goods logistics system according to claim 8, wherein the parameter e) is additionally causally linked to:
i) at least one sensor signal of at least one occupancy sensor of the at least one start loading aid station which indicate whether the loading aid stations are free or occupied, and/or
ii) a parameter of the sequence control of the transport tasks and/or traffic control of the at least one driverless industrial trucks in the transport region which indicates whether the loading aid station is free or occupied,
wherein the transport task is only generated if the start loading aid station is occupied and the destination loading aid station is free.

11. The goods logistics system according to claim 1, wherein the master computer is further configured to change a status of at least one loading aid station assigned to the at least one sensor or switch, based on the trigger signal with the application of a stored status change definition, to activate or deactivate the loading aid station.

12. A method for operating a goods logistics system, wherein the method comprises:
generating a trigger signal by at least one input units and transmitting the trigger signal to a master computer,
wherein the master computer is configured to:
a) generate, changes, or deletes a transport task to be carried out in a transport region by at least one driverless industrial trucks based on the trigger signal with the application of a stored transport task definition and transmits a transport task signal linked to this transport task to the industrial truck, wherein the industrial truck performs the transport task in response to the transport task signal, and/or
b) change a status of at least one loading aid station assigned to the at least one input unit based on the trigger signal with the application of a stored status change definition activates or deactivates the loading aid station, wherein
the transport task definition stored in the master computer and the status change definition stored in the master computer are changeable.

13. The method according to claim 12, wherein the goods logistics system further comprises a secondary computer, wherein the master computer grants the secondary computer access to the transport task definition and/or status change definition and the secondary computer changes the transport task definition and/or status change definition.

14. The method according to claim 12, wherein the transport task comprises conveying a loading aid from a first loading aid station to a second loading-aid station along a transport path within the transport region.

15. The method according to claim 12, wherein the master computer provides sequence control for the transport tasks and/or traffic control for the at least one driverless industrial trucks in the transport region and generates the transport task taking into account the parameters of the sequence control and/or traffic control.

16. The method according to claim 13, wherein the goods logistics system is implemented in a goods logistics facility, wherein the goods logistics facility is realized on the basis of a planning model and uses data saved in a logistics facility project file, and wherein the logistics facility project file comprises data that describe properties of at least one of the following components of the goods logistics facility:
structural properties of a building of the goods logistics facility,
geometric and/or functional properties of the transport region and/or transport path,
geometric and/or functional properties of logistics infrastructure elements of the first and second loading aid station,
geometric and/or functional properties of the at least one driverless industrial trucks,
wherein parameters of the transport task definition are further stored in the logistics facility project file.

17. The method according to claim 12, wherein the changeable transport task definition is defined in a causally linked parameter space and can be changed at the master computer or secondary computer, and the parameter space comprises the following as parameters:
a) the at least one input units (24) present in the goods logistics system
b) for each input unit of the at least one input units included, one or more possible types of trigger signals that can be generated thereby, and
c) for each trigger signal of each input unit of the at least one input units, one or more status change requests of a transport task, for generating, changing, or deleting the transport task,
for each transport task, provided that the status change request specifies generating or changing the transport task or status change request, the parameter space comprises the following as parameters:
d) at least one start loading aid stations, and
e) at least one destination loading aid stations.

18. The method according to claim 17, wherein the parameter d) is additionally causally linked to:
i) at least one sensor signal of at least one occupancy sensor of the at least one start loading aid station or sensor signals of occupancy sensors of the group of start loading aid stations which indicates whether the at least one loading aid station is free or occupied, and/or
ii) a parameter of the sequence control of the transport tasks and/or traffic control of the at least one driverless industrial trucks in the transport region which indicates whether the loading aid station is free or occupied,
wherein the transport task is only generated if the start loading aid station is occupied and the destination loading aid station is free.

19. The method according to claim 17, wherein the parameter e) is additionally causally linked to:
i) at least one sensor signal of at least one occupancy sensor of the at least one start loading aid station which indicates whether the at least one loading aid station is free or occupied, and/or
ii) a parameter of the sequence control of the transport tasks and/or traffic control of the at least one driverless industrial trucks in the transport region which indicates whether the loading aid station is free or occupied,
wherein the transport task is only generated if the start loading aid station is occupied and the destination loading aid station is free.

20. A control apparatus for operating a goods logistics system, the control apparatus comprising:
a master computer configured to:
generate a trigger signal by at least one input unit and transmit the trigger signal to the master computer,
a) generate, change, or delete a transport task to be carried out in a transport region by at least one driverless industrial truck operating in the transport region based on the trigger signal with the application of a stored transport task definition and transmit a transport task signal linked to this transport task to the at least one industrial truck, wherein the at least one industrial truck performs the transport task in response to the transport task signal, and/or
b) change a status of at least one loading aid station assigned to the at least one input unit based on the trigger signal with the application of a stored status change definition activate or deactivate the loading aid station,
wherein the transport task definition stored in the master computer and the status change definition stored in the master computer are changeable.
